(19) United States
(12) Patent Application Publication
(10) Pub. No.: US 2019/0092982 A1
(43) Pub. Date: Mar. 28, 2019

(54) COVER TAPE

(71) Applicant: JENIMETAL CHEMICAL FACTORY CO., LTD., Taipei City (TW)

(72) Inventors: Yo-Hua WU, Taipei City (TW); Po-Shiun WU, Taipei City (TW)

(73) Assignee: JENIMETAL CHEMICAL FACTORY CO., LTD., Taipei City (TW)

(21) Appl. No.: 16/143,687

(22) Filed: Sep. 27, 2018

(30) Foreign Application Priority Data
Sep. 28, 2017 (TW) 106133405

(51) Int. Cl. C09J 7/40; C09J 7/22; C09J 7/38

(52) U.S. Cl. CPC C09J 7/403; B32B 7/12; C09J 7/38; C09J 7/22

(57) ABSTRACT

A cover tape includes first and second basal layers, a first adhesive layer having a low peeling-strength and disposed between the first and second basal layers, and a second adhesive layer having a high peeling-strength and disposed on the other surface of the second basal layer. The cover tape adheres to two ends of a carrier tape. Two vertically-extending notches are disposed at two ends of the second basal layer and correspond in position to points of coupling to the carrier tape, respectively. Defined on the second basal layer are a centrally-located central release portion and fixing portions disposed at two ends of the second basal layer. Peeling off the cover tape entails separating the first basal layer from the two fixing portions of the second basal layer under a stable, small pulling force and separating the central release portion and the first basal layer from the carrier tape.

### BACKGROUND OF THE INVENTION

### 1. Technical Field

The present disclosure relates to cover tape structures and, more particularly, to a cover tape which is not only adapted for use in heat sealing and self adhesion but is also single-style applicable to carrier tapes made of different materials and still attains controllable, stable peeling strength.

### 2. Description of Related Art

A plastic carrier tape, adapted to facilitate SMT (surface mounted technology) patch production, is an important packaging material. A conventional carrier tape is manufactured by performing processing processes, such as shaping and punching, on a plastic carrier tape strip (material strip) to form dents and side holes, which take on predetermined shapes. The dents accommodate electronic parts and components. The side holes are for use in positioning. Afterward, the carrier tape thus manufactured is sealed by a cover tape, so as to package the electronic parts and components. Design of various electronic products has a trend toward lighter, thinner and smaller products; hence, consumer electronics have a noticeable trend toward compactness and delicacy, giving rise to increasingly strong demand for SMT in terms of production capacity, precision, quality and service.

According to the prior art, cover tapes coupled to carrier tapes fall into two categories: heat-sealing cover tapes and self-adhesive cover tapes. The heat-sealing cover tapes acquire adhesiveness by heating a heat-activated binder (also known as heat-melting adhesive); hence, the cover tapes, which are monolayer, can be adhered to the carrier tapes. By contrast, the self-adhesive cover tapes are laminated in the presence of a pressure sensitive binder (also known as self adhesive or pressure sensitive adhesive (PSA)) such that the monolayer cover tapes can be adhered to the carrier tapes. However, in practice, the aforesaid two types of cover tapes have drawbacks described below.

First, the heat sealing cover tapes each come with a specific heat-melting adhesive and corresponding processing criteria in accordance with the material which the carrier tape is made of. The prior art is not only complicated but also has high equipment requirements. In practice, the prior art can achieve sealing, only with a heating device. After heat sealing has been achieved, the seal is likely to rupture because of the surroundings. Furthermore, according to the prior art, a production process entails adjusting temperature and pressure to the detriment of ease of use.

Second, the self-adhesive cover tapes have strict requirements for pressure sensitive binders as follows: not only is a high degree of sealing strength required to meet demand, but appropriate pressure sensitive binders must also be produced in accordance with the materials which the carrier tapes are made of to control the stability of peeling the cover tapes, so as to prevent inadequacy of sealing strength and prevent traces of the binders from remaining on the surfaces of the carrier tapes after peeling. In addition, the surroundings predispose the seal to failure, leading to an overly great tensile force and thus instability thereof, not to mention that residual adhesive is readily found at the tape edges in direct contact with the product while a peeling process takes place, thereby imposing adverse effects on machines.

The aforesaid conventional heat-sealing cover tapes and self-adhesive cover tapes stabilize a peeling strength because of constituents of an adhesive. However, in practice, factors, such as applicable carrier tape materials (carrier tape surface materials) and the surroundings (temperature and humidity), have an effect on the stability of an acting force associated with sealing adhesive peeling, leading to variations in the peeling strength of carrier tapes, uneven peeling strength, vulnerable stability of an acting force associated with peeling the cover tape off the carrier tape, as well as resultant shifts, jerks and adhesion of parts and components. To overcome the aforesaid drawbacks, the present disclosure provides a central-release cover tape whereby cover tape peeling is optimized to control the peeling-related pulling force so that it falls within a stable range.

Referring to FIG. 1, a conventional central release cover tape structure is implemented as a cover tape 6. The cover tape 6 comprises a slender, sheetlike substrate 61 and a pressure sensitive adhesive layer 62 dispose beneath the substrate 61. An external carrier tape (not shown) is adhered to the pressure sensitive adhesive layer 62. A membrane layer 64 is disposed on a surface of the pressure sensitive adhesive layer 62 and positioned distal to the substrate 61. An array of miniature incisions is disposed at each of the two ends of the substrate 61 by laser or any other processing process. Each array of miniature incisions comprises a plurality of curved miniature incisions 63 spaced apart from each other but not penetrating the substrate 61. In practice, the miniature incisions 63 reduce the structural strength at two ends of the substrate 61 such that a stable ruptured opening is formed along the path of extension of each of the two arrays of miniature incisions when the cover tape 6 is subjected to an external force.

Referring to FIG. 2, an upper plated layer 71 and a bottom plated layer 72 are disposed on the upper and lower surfaces of a slender, sheetlike cover tape 7, respectively. An adhesive slip 73 is disposed at each of the two ends of the bottom plated layer 72. The two adhesive slips 73 adhere to two ends of an external carrier tape (not shown), respectively. Half-torn openings 74, 75 (which are continuous or discrete) are formed on upper and lower surfaces of the cover tape 7 and positioned proximate to the two ends thereof. The half-torn openings 74, 75, which do not penetrate the cover tape 7, reduce the structural strength at the two ends of the cover tape 7 and thus define severable points at the two ends of the cover tape 7 such that the cover tape 7 in operation can separate from the carrier tape by severing at the severable points rather than peeling off the adhesive slips between the cover tape 7 and the carrier tape, so as to preclude sealing instability otherwise caused by factors, such as the carrier tape materials and the surroundings. However, both the miniature incisions 63 and the half-torn openings 74, 75 have disadvantages, namely intricate, inconvenient processing process, unstable quality, high processing costs, and low price competitiveness. As a result, overall product competitiveness is low.

Design of cover tapes is closely related to applicable carrier tape materials. Common carrier tape materials are polystyrene (PS), polycarbonate (PC), polyethylene terephthalate (PET), and polypropylene (PP). These materials vary in physical properties. Carrier tapes require customized cover tapes and sealing glue in order to meet needs, such as stability, peeling strength, and sealing strength of the cover tapes. Therefore, it is almost impossible to meet the sealing requirements of carrier tapes made of whatever material with just a single cover tape design.

Since conventional cover tapes have aforesaid drawbacks in terms of application and peeling, the inventor of the present disclosure conducts research to overcome the aforesaid drawbacks and thus puts forth the present disclosure.

### BRIEF SUMMARY OF THE INVENTION

The present disclosure provides an all-in-one approach to overcoming the aforesaid drawbacks of the prior art, by abandoning the conventional heat-sealing technique, self-adhesive cover tapes and pull technique used in carrier tape peeling, but adopting a separable bilayer fixing portion to allow the second layer of the fixing portion to be fully sealed on the two sides of the carrier tape by heavy-adhesion and thus become no longer restricted to the materials of the carrier tape, and then allow the first layer to be adhered to the fixing portion by light-adhesion with controllable peeling strength such that, to allow the cover tape to peel off the carrier tape, the first layer separates from the fixing portion under a stable pulling force (i.e., peeling strength), so as to be permanently stabilized at 20˜90 g or even at 20˜70 g and thus no longer restricted to factors, including the materials of the carrier tape and the surroundings, so as to achieve universality (single-style applicable to carrier tapes made of any materials or badly shaped.)

It is an objective of the present disclosure to provide a cover tape, including two sheetlike, stacked first and second basal layers, and a first adhesive layer disposed therebetween and having low adhesiveness. On the other side of the second basal layer, a second adhesive layer having high adhesiveness is adhered to the two sides of the carrier tape. A vertically extending, penetrating notch is disposed on two sides of the second basal layer and a coupling point on the carrier tape. The two notches extend along the edge and divide the second basal layer to define a centrally-located central release portion and fixing portions located on two sides. When the first and second basal layers are subjected to a force, the two fixing portions peel off from the surface of the first adhesive layer such that the central release portion separates from the carrier tape together with the first basal layer. Hence, the present disclosure is not only effective in eliminating the differences in stability of a peeling strength, which might otherwise happen to various adhesives applied to different carrier tape materials, but also effective in precluding shifts and jerks of parts and components, which might otherwise occur under an uneven peeling strength.

Another objective of the present disclosure is to provide a cover tape. The second adhesive layer of the cover tape is implemented as a heat-melting adhesive or a pressure sensitive adhesive as needed so as to meet needs in different situations. Therefore, the present disclosure has wide application.

Yet another objective of the present disclosure is to provide a cover tape. The cover tape is, on the whole, simple to process and incur low costs. The first basal layer of the cover tape can be easily redone and reused; hence, the present disclosure incurs low costs and is cost-effective.

In order to achieve the above and other objectives and advantages, the present disclosure provides a cover tape, comprising: a stripelike first basal layer; a sheetlike second basal layer similar to the first basal layer in shape; a first adhesive layer disposed on a surface of the first basal layer and positioned proximate to the second basal layer to adhere to the first and second basal layers and generate a corresponding first peeling strength such that the first basal layer peels off the second basal layer when pulled; a second adhesive layer disposed on a surface of the second basal layer and positioned distal to the first basal layer to adhere to the second basal layer and the carrier tape and generate a corresponding second peeling strength, the second peeling strength being greater than the first peeling strength; wherein two vertically-extending notches are disposed at two ends of the second basal layer, respectively, such that the second basal layer is divided to thereby define a centrally-located central release portion and fixing portions located at the two ends of the second basal layer, respectively, to adhere to fixing portions of the carrier tape, so as to peel the cover tape off the carrier tape by separating the first basal layer from the two fixing portions of the second basal layer under a pulling force of the first peeling strength while keeping the two fixing portions adhered to the carrier tape and allowing the central release portion to separate from the carrier tape together with the first basal layer.

Regarding the aforesaid structure, a surface of the first basal layer is covered with a functional coating layer positioned distal to the second basal layer.

Regarding the aforesaid structure, the functional coating layer is an anti-static layer.

Regarding the aforesaid structure, the first and second basal layers are made of polyethylene terephthalate (PET) or O-phenylphenol (OPP).

Regarding the aforesaid structure, the first adhesive layer is a lightly-adhesive pressure sensitive adhesive (PSA) with a low peeling strength.

Regarding the aforesaid structure, the peeling strength imposed by the first adhesive layer on between the first basal layer and the two fixing portions controllably falls within 20˜70 g, 20˜80 g or 20˜90 g.

Regarding the aforesaid structure, the second adhesive layer is a heavily-adhesive heat-melting adhesive or a heavily-adhesive pressure sensitive adhesive (PSA), with a high peeling strength.

Regarding the aforesaid structure, the peeling strength imposed by the second adhesive layer on between the carrier tape and the two fixing portions of the second basal layer is, at the very least, controllably set to above 100 g or above 120 g.

Regarding the aforesaid structure, a surface of the second adhesive layer is covered with a functional coating layer positioned distal to the second basal layer and corresponding in position to the central release portion.

Regarding the aforesaid structure, the functional coating layer is an anti-static layer.

### BRIEF DESCRIPTION OF THE SEVERAL VIEWS OF THE DRAWINGS

FIG. 1 (PRIOR ART) is a lateral cross-sectional view of a conventional release cover tape structure;

FIG. 2 (PRIOR ART) is a lateral cross-sectional view of a conventional central release cover tape structure;

FIG. 3 is a lateral cross-sectional view of a cover tape according to the first embodiment of the present disclosure;

FIG. 4 is a schematic view of the cover tape being peeled off according to the first embodiment of the present disclosure;

FIG. 5 is a partial enlarged view of region X shown in FIG. 4;

FIG. 6 is a lateral cross-sectional view of the cover tape according to the second embodiment of the present disclosure;

FIG. 7 is a schematic view of the cover tape being peeled off according to the second embodiment of the present disclosure; and

FIG. 8 is a partial enlarged view of region Y shown in FIG. 7.

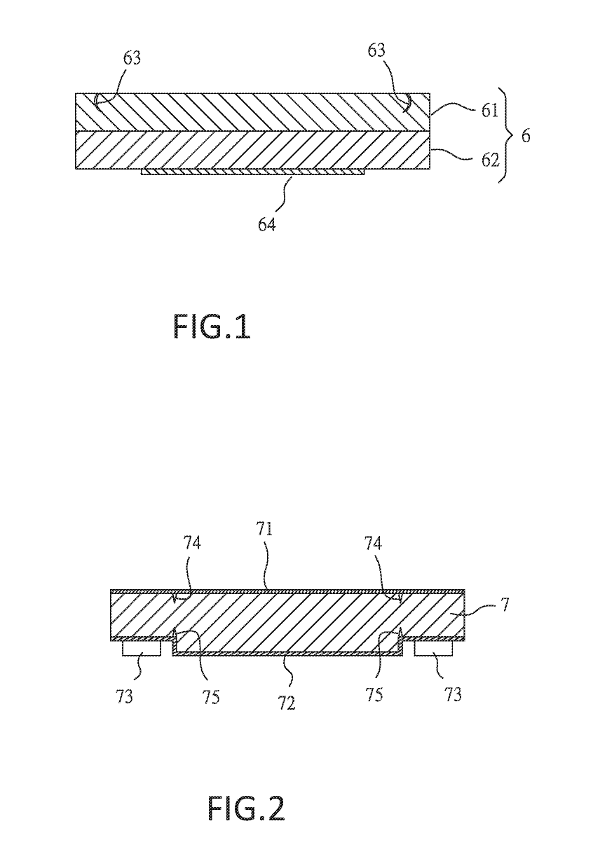

### DETAILED DESCRIPTION OF THE INVENTION

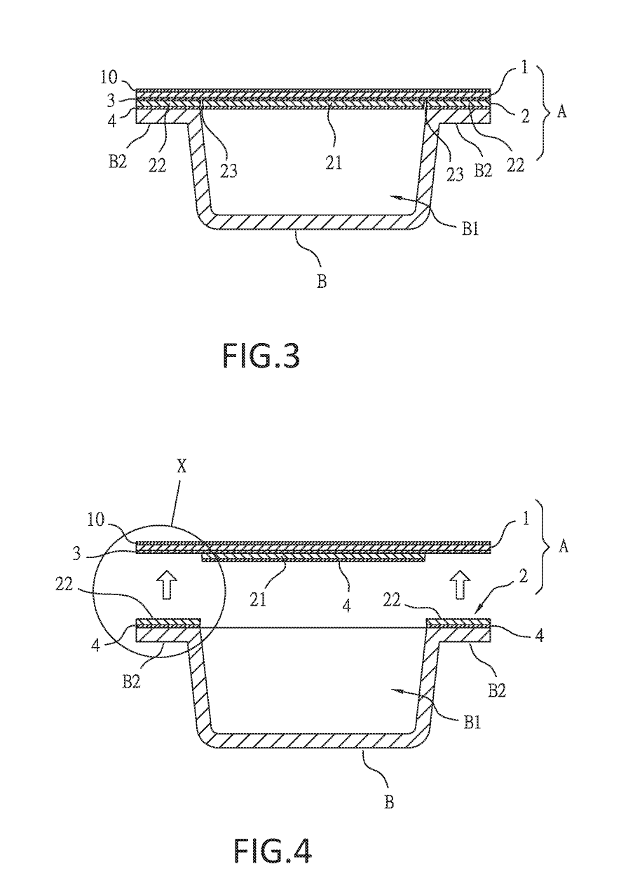

Referring to FIG. 3 through FIG. 5, the first embodiment of the present disclosure is exemplified by a heat-sealing cover tape A which essentially comprises a first basal layer 1, a second basal layer 2, a first adhesive layer 3 and a second adhesive layer 4. The first basal layer 1 is a stripelike structure made of polyethylene terephthalate (PET) or O-phenylphenol (OPP). In a variable embodiment of the present disclosure, the first basal layer 1 is made of polystyrene (PS), acrylonitrile butadiene styrene (ABS), or polycarbonate (PC) and formed by heating, injection and lamination to ensure that the first basal layer 1 has satisfactory physical properties, such as toughness, mechanical strength, and resistance to impacts.

The second basal layer 2 is a sheetlike structure which is similar or identical to the first basal layer 1 in terms of size and shape. The second basal layer 2 lies beneath the first basal layer 1 and is made of the same material as the first basal layer 1.

The first adhesive layer 3 is disposed between the first and second basal layers 1, 2. Thanks to the adhesiveness of the first adhesive layer 3, a proportionate first peeling strength is generated between the first and second basal layers 1, 2.

In this embodiment, the first adhesive layer 3 is a lightly-adhesive pressure sensitive adhesive (PSA).

The second adhesive layer 4 is disposed below the second basal layer 2 and faces away from the first basal layer 1. The second adhesive layer 4, a heavily-adhesive heat sealing adhesive (with stronger adhesiveness than the first adhesive layer 3), undergoes a heat sealing process and adheres to two sides of a predetermined carrier tape B, so as to generate a second peeling strength greater than the first peeling strength.

In this embodiment, the second adhesive layer 4 is a heavily-adhesive heat-melting adhesive or any other adhesive which generates a great sealing force when subjected to heat adhesion.

In a practical embodiment, a penetrating, cutting notch 23 is disposed at each of the two ends of the second basal layer 2. The two notches 23 extend vertically along the edges of the second basal layer 2, respectively, such that the second basal layer 2 is divided to thereby define a centrally-located central release portion 21 corresponding in position to the receiving space B1 and fixing portions 22 located at the two ends of the second basal layer 2, respectively, and corresponding in position to the lateral side portions B2, respectively.

The plurality of receiving spaces B1 is centrally disposed at the carrier tape B and equidistantly spaced apart to accommodate predetermined electronic parts and components (not shown). A flat lateral side portion B2 is disposed at each of the two ends of the carrier tape B. In practice, a heat sealing process is performed on the two fixing portions 22 such that the second adhesive layer 4 of the two fixing portions 22 is heated up, pressed and adhered to the lateral side portions B2 at the two ends of the carrier tape B.

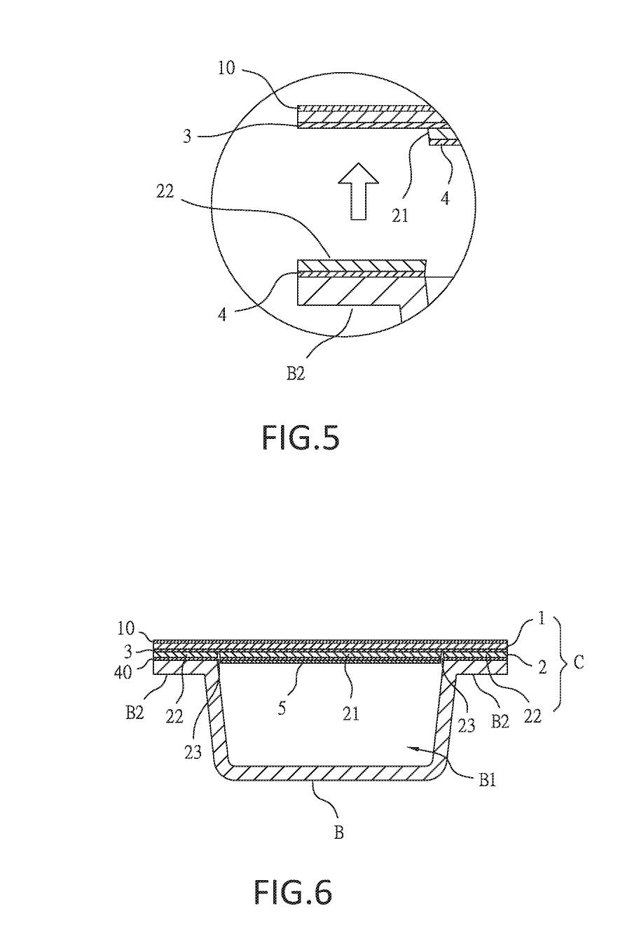

Regarding the aforesaid structure, the second adhesive layer 4 of the fixing portions 22 at the two ends of the second basal layer 2 of the cover tape A undergoes a heat sealing process and thereby adheres to the lateral side portions B2 of the carrier tape B. The other surface of each fixing portion 22 is adhered to the first basal layer 1 through the first adhesive layer 3. The second adhesive layer 4 has a greater peeling strength than the first adhesive layer 3. Since the first adhesive layer 3 has a lower peeling strength than the second adhesive layer 4, when the cover tape A is subjected to an external force (pulling acting force, as shown in FIG. 5) exerted in a direction away from the carrier tape B, the two fixing portions 22 of the second basal layer 2 separate from the first basal layer 1 by separating from the first adhesive layer 3. Afterward, the other sides of the fixing portions 22 are still adhered to the two lateral side portions B2 of the carrier tape B through the second adhesive layer 4. The central release portion 21 separates from the carrier tape B together with the first basal layer 1 to finalize the operation of peeling off the cover tape A and opening the receiving space B1 of the carrier tape B.

Regarding the aforesaid structure of the present disclosure, the peeling operation is rendered easy and efficient by the two fixing portions 22 of the second basal layer 2 and the first basal layer 1, that is, a bilayer layer structure, and effective in controlling the peeling strength between the first basal layer 1 and the second basal layer 2 by selecting appropriating materials of the first basal layer 1 and the second basal layer 2 and employing the adhesive characteristics of the first adhesive layer 3, so as to optimize the peeling strength between the cover tape A and the carrier tape B (controllably allowing the peeling strength achieved by the first adhesive layer 3 and imposed between the first basal layer 1 and the two fixing portions 22 to fall within 20˜70 g, 20˜80 g, 20˜90 g, preferably 20˜80 g for the sake of advantages and cost control.) Furthermore, the two fixing portions 22 of the second basal layer 2 are separable and sealed on the carrier tape B; hence, the second adhesive layer 4 is implemented as a heavily-adhesive heat-melting adhesive so as to effectuate complete sealing and thus is not restricted to the materials of the carrier tape B (the peeling strength imposed by the second adhesive layer 4 on between the carrier tape B and the two fixing portions 22 of the second basal layer 2 is controllably set to be above 100 g or above 120 g, at the very least). Owing to the difference in the peeling strength between the two separable fixing portions 22 and the flanking first and second adhesive layers 3, 4, the overall design is effective in ensuring the stability of the peeling process, applying to carrier tapes made of different materials, and precluding shifts and jerks of parts and components which might otherwise arise from uneven peeling strength.

In practice, a surface of the first basal layer 1 is covered with a functional coating layer 10 (which is a conductive layer or anti-static layer) positioned distal to the second basal layer 2, as needed. The functional coating layer 10 is made of resin (for example, acrylic resin, polyoxy resin, polyurethane resin, unsaturated polyester resin, saturated polyester resin, or epoxy resin) which contains an additive, that is, a conducting agent (for example, carbon nanotube or conductive polymer). The resin is coated on the surface of the first basal layer 1 by dip coating, roll coating or spray coating. The resin and the first basal layer 1 together not only effectuate satisfactory compatible adhesion but also acquire a conductive or anti-static function in the presence of the conducting agent to prevent ambient static electricity from damaging electronic parts and components inside the receiving space B1. In practice, a surface of the second adhesive layer 4 is covered with a functional coating positioned distal to the second basal layer 2, so as to form the conductive layer or anti-static layer and thus augment the protection for electronic parts and components inside the receiving space B1.

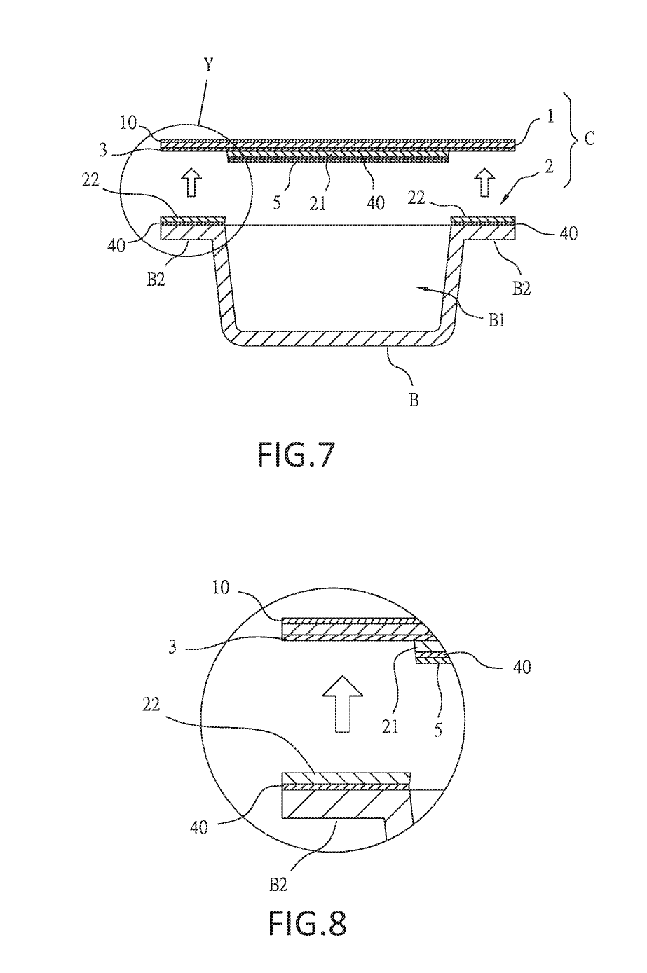

Referring to FIG. 6 through FIG. 8, the second embodiment of the present disclosure is exemplified by a self-adhesive cover tape C. In addition to the first basal layer 1, second basal layer 2 and first adhesive layer 3 of the first embodiment, the cover tape C of the second embodiment comprises a second adhesive layer 40. As shown in the diagrams, the first basal layer 1, second basal layer 2 and first adhesive layer 3 are connected and coupled together in the second embodiment in the same way as they are in the first embodiment except that, in the second embodiment, the second adhesive layer 40 is made of an adhesive with a greater peeling strength than the first adhesive layer 3 (made of lightly-adhesive PSA), and the adhesive is a heavily-adhesive PSA (pressure sensitive adhesive) disposed on the lower surface of the second basal layer 2, positioned distal to the first basal layer 1 and, at the very least, disposed between the two fixing portions 22 and the two ends of the carrier tape B such that the fixing portions 22 at the two ends of the second basal layer 2 are pressed and sealed on the lateral side portions B2 of the carrier tape B by the second adhesive layer 40, whereas the other surfaces of the fixing portions 22 are coupled to the first basal layer 1 through the first adhesive layer 3, and the second adhesive layer 40 has a greater peeling strength than the first adhesive layer 3.

Since the first adhesive layer 3 has a lower peeling strength than the second adhesive layer 40, when the cover tape C is subjected to an external force (pulling acting force, as shown in FIG. 8) exerted in a direction away from the carrier tape B, the two fixing portions 22 of the second basal layer 2 separate from the first basal layer 1 by separating from the first adhesive layer 3. Afterward, the two fixing portions 22 are still adhered to the two lateral side portions B2 of the carrier tape B by the second adhesive layer 40, respectively, and the central release portion 21 separates from the carrier tape B together with the first basal layer 1 to finalize the operation of peeling off the cover tape A and open the receiving space B1 of the carrier tape B.

Like the first embodiment, the second embodiment provides a self-adhesive cover tape characterized in that the peeling operation is rendered easy and efficient by the two fixing portions 22 of the second basal layer 2 and the first basal layer 1, that is, a bilayer layer structure, and effective in controlling the peeling strength between the first basal layer 1 and the second basal layer 2 by selecting appropriating materials of the first basal layer 1 and the second basal layer 2 and employing the adhesive characteristics of the first adhesive layer 3, so as to optimize the peeling strength between the cover tape A and the carrier tape B (controllably allowing the peeling strength achieved by the first adhesive layer 3 and imposed between the first basal layer 1 and the two fixing portions 22 to fall within 20˜70 g, 20˜80 g, 20˜90 g, preferably 20˜80 g for the sake of advantages and cost control.) Furthermore, the two fixing portions 22 of the second basal layer 2 are separable and sealed on the carrier tape B; hence, the second adhesive layer 40 is implemented as a heavily-adhesive pressure sensitive adhesive (PSA) so as to effectuate complete sealing and thus is not restricted to the materials of the carrier tape B (the peeling strength imposed by the second adhesive layer 40 on between the carrier tape B and the two fixing portions 22 of the second basal layer 2 is controllably set to be above 100 g or above 120 g, at the very least). Owing to the difference in the peeling strength between the two separable fixing portions 22 and the flanking first and second adhesive layers 3, 40, the overall design is effective in ensuring the stability of the peeling process, applying to carrier tapes made of different materials, and precluding shifts and jerks of parts and components which might otherwise arise from uneven peeling strength.

In practice, a surface of the first basal layer 1 is covered with a functional coating layer 10 (which is a conductive layer or anti-static layer) positioned distal to the second basal layer 2, as needed, to prevent ambient static electricity from damaging electronic parts and components inside the receiving space B1. A surface of the second adhesive layer 40 is covered with a functional coating layer 5 positioned distal to the second basal layer 2. The functional coating layer 5 is made of the same material and has the same structure as the functional coating layer 10. The functional coating layer 5 corresponds in position to the central release portion 21 substantially to not only provide an anti-static effect but also prevent the second adhesive layer 40 on the surface of the second basal layer 2 from adhering to the electronic parts and components inside the receiving space B1.

In conclusion, a cover tape of the present disclosure has wide application, maintains a stable adhesion force, and thus effectively prevents shifts, jerks and adhesion of parts and components in the course of peeling off the cover tape. Therefore, the present disclosure has novelty and non-obviousness. However, the above description is just about preferred embodiments of the present disclosure. All variations, modifications, changes and equivalent replacements made to the preferred embodiments of the present disclosure in accordance with the technical measures and scope of the present disclosure are deemed falling within the scope of the claims of the present disclosure.

What is claimed is:

1. A cover tape, for sealing a predetermined carrier tape, comprising:
a stripelike first basal layer;
a sheetlike second basal layer similar to the first basal layer in shape;
a first adhesive layer disposed on a surface of the first basal layer and positioned proximate to the second basal layer to adhere to the first and second basal layers and generate a corresponding first peeling strength such that the first basal layer peels off the second basal layer when pulled;
a second adhesive layer disposed on a surface of the second basal layer and positioned distal to the first basal layer to adhere to the second basal layer and the carrier tape and generate a corresponding second peeling strength, the second peeling strength being greater than the first peeling strength;
wherein two vertically-extending notches are disposed at two ends of the second basal layer, respectively, such that the second basal layer is divided to thereby define a centrally-located central release portion and fixing portions located at the two ends of the second basal layer, respectively, to adhere to fixing portions of the carrier tape, so as to peel the cover tape off the carrier tape by separating the first basal layer from the two fixing portions of the second basal layer under a pulling force of the first peeling strength while keeping the two fixing portions of the second basal layer adhered to the carrier tape and allowing the central release portion to separate from the carrier tape together with the first basal layer.

2. The cover tape of claim 1, wherein a surface of the first basal layer is covered with a functional coating layer positioned distal to the second basal layer.

3. The cover tape of claim 2, wherein the functional coating layer is an anti-static layer.

4. The cover tape of claim 1, wherein the first and second basal layers are made of PET or OPP.

5. The cover tape of claim 1, wherein the first adhesive layer is a lightly-adhesive PSA with a low peeling strength.

6. The cover tape of claim 5, wherein the peeling strength imposed by the first adhesive layer on between the first basal layer and the two fixing portions falls within 20˜80 g.

7. The cover tape of claim 1, wherein the second adhesive layer is a heavily-adhesive heat-melting adhesive or a heavily-adhesive PSA, with a high peeling strength.

8. The cover tape of claim 7, wherein the peeling strength imposed by the second adhesive layer on between the carrier tape and the two fixing portions of the second basal layer is above 100 g.

9. The cover tape of claim 8, wherein a surface of the second adhesive layer is covered with a functional coating layer positioned distal to the second basal layer and corresponding in position to the central release portion.

10. The cover tape of claim 9, wherein the functional coating layer is an anti-static layer.
